(19) United States
(12) Patent Application Publication
(10) Pub. No.: US 2026/0190197 A1
(43) Pub. Date: Jul. 2, 2026

(54) Control circuit for a light-emitting diode string

(71) Applicant: Anapex Technology Inc., Jhubei City (TW)

(72) Inventors: TSUNG-WEN HUANG, Jhubei City (TW); CHI-MIN LAI, Jhubei City (TW)

(21) Appl. No.: 19/432,790

(22) Filed: Dec. 24, 2025

(30) Foreign Application Priority Data
Dec. 27, 2024 (TW) 113151215

(51) Int. Cl. H05B 45/54; H05B 45/30; H05B 45/52

(52) U.S. Cl. CPC H05B 45/54; H05B 45/30; H05B 45/52

(57) ABSTRACT

A control circuit and a configuration method for an LED string are disclosed. The LED string includes n LED units connected in series. A controller sends a setting signal including mᵢ bits sent to the LED units. Each LED unit counts a number of bits mᵢ of the setting signal. These operations are repeated x times, where x is an integer from 1 to not greater than (n−1) and i is from 1 to x, and the bit count obtained in each repetition is cumulatively added for each LED unit. An xth LED unit, upon receiving an (x−1)th setting signal, writes an accumulated count into a temporary storage element of the LED unit. The controller then sends a programming signal to the LED units, and each LED unit writes the accumulated count stored in the temporary storage element into a storage element of the LED unit.

### FIELD OF THE INVENTION

The present invention relates to an LED string, and particularly to a control circuit and a method for configuring the LED string.

### BACKGROUND OF THE INVENTION

Light-emitting diodes (LEDs) have characteristics such as high luminous efficiency, small size, and high durability, and have been widely and maturely used in various applications including lighting, displays, and decorative lights. As usage requirements diversify, it has become common for lighting modules to include LEDs of different quantities and colors. Accordingly, LEDs are frequently arranged in the form of an LED string as a lighting module.

In conventional LED strings, the LEDs are connected in series to a controller through a single daisy-chain line, and driving signals are transmitted to the LEDs in the order in which they are connected. If any one LED fails, all LEDs located downstream in the series connection will be unable to emit light, thereby affecting the lighting performance of the entire string. For this reason, solutions employing parallel LED connections have been developed, such as those disclosed in Chinese Patent Nos. CN 109729628B and CN 114842792B, to address problems associated with series-connected LEDs.

However, individual LEDs do not contain an identification code in memory when they leave the factory, such that the controller cannot distinguish between the LEDs. Therefore, in practical applications, each LED must first be addressed by assigning an identification code.

In the above prior art, Chinese Patent No. CN 109729628B adopts a signal-distribution approach; however, the data exchange involved is complex, resulting in a longer configuration time and a higher likelihood of errors. Chinese Patent No. CN 114842792B merely describes that each LED has an identification code, without disclosing how the identification code is obtained.

### SUMMARY OF THE INVENTION

In at least one example of the present disclosure, a control circuit for an LED string is provided. The LED string includes n LED units connected in series, where n is a number of the LED units. An input terminal of each LED unit is connected to a controller through a first line, and a bidirectional terminal and an output terminal of the LED units are connected in series with each other and to the controller through a second line. Each LED unit includes an LED chip, a driver circuit, a storage element, a temporary storage element, and a counter. The d river circuit is connected to the LED chip, the storage element, the temporary storage element, and the counter.

In operation, the controller sends to the LED units a setting signal including mᵢ bits, and the counter of each LED unit counts a number of bits mᵢ of the setting signal. These operations are repeated x times, where x is an integer from 1 to not greater than n−1, and i is from 1 to x. The bit count obtained in each repetition is cumulatively added, resulting in a first accumulated count. An (x)th LED unit, upon receiving an (x−1)th setting signal, writes the first accumulated count into its temporary storage element. The controller then sends a programming signal, and each LED unit writes the first accumulated count stored in its temporary storage element into its storage element. The first accumulated count written into the storage elements is different for the respective LED units, enabling each LED unit in the LED string to be individually identified and controlled.

### BRIEF DESCRIPTION OF THE DRAWINGS

Example embodiments of the present disclosure will be described with reference to the accompanying drawings briefly described below.

FIG. 1 is a schematic diagram illustrating an architecture of a control circuit for an LED string according to an embodiment of the present invention.

FIG. 2 is a timing diagram illustrating signal operations according to an embodiment of the present invention.

FIG. 3 is another timing diagram illustrating signal operations according to an embodiment of the present invention.

### DETAILED DESCRIPTION

It should be understood that the terminology used in the description of various embodiments is for illustration only and is not intended to be limiting. Unless otherwise explicitly stated by context or the number of components is deliberately restricted, the singular terms such as “a”, “an” or “the” also include plural forms. Furthermore, the terms “including” and “comprising” indicate the presence of the stated features, components, and/or assemblies without excluding the addition or presence of one or more other features, components, assemblies, or their combinations. Indefinite and definite articles are intended to include both singular and plural meanings unless the context clearly indicates otherwise.

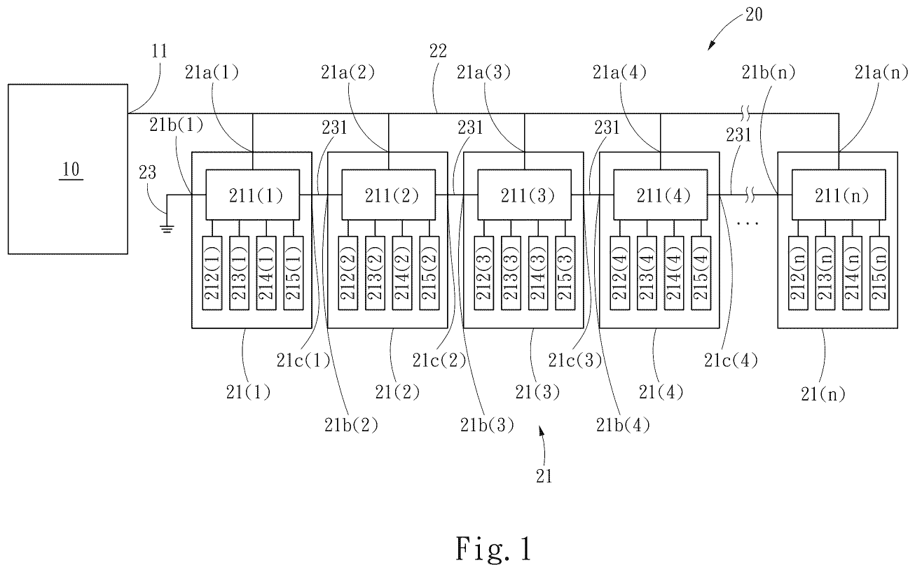

Referring to FIG. 1, the present invention discloses a control architecture configured to operate a plurality of light-emitting diode (LED) units arranged as an LED string. In particular, the control architecture is configured to broadcast control signals and propagate data in a daisy-chain manner among the LED string. A control circuit 1 shown in FIG. 1 includes a controller 10 and an LED string 20. The LED string 20 is connected to and controlled by the controller 10. The control performed by the controller 10 may include both configuration of the LED string 20 and driving of the LED units 21 for light emission. In an example, the configuration is performed to prepare the LED string for subsequent operation, such that the LED units 21 can be individually distinguished and controlled during normal lighting operation. In one example, the configuration includes a setting process for assigning identification to each of the LED units 21 on the LED string 20. Through the setting process, each of the LED units 21 is associated with a respective identification, thereby enabling the controller 10 to distinguish the LED units 21 from one another and to individually address the LED units 21 during driving. In one example, the assigning of the identification during the setting process may involve programming the identification into a storage element of the LED unit 21. However, the manner in which the identification is stored or retained is not limited thereto, and other implementations for storing, retaining, or otherwise associating the identification with the LED unit 21 may also be employed.

The configuration may be performed by the controller 10 before the LED string 20 is placed into normal operation and/or after completion of assembly. By virtue of the identification assigned during the configuration, the controller 10 is able to individually address and independently control each of the LED units 21 on the LED string 20, thereby enabling independent control of lighting characteristics of the respective LED units 21 even in a serially connected LED string architecture.

In this way, each LED unit 21 on the LED string 20 can be distinguished and identified, and the controller 10 can recognize each LED unit 21 and provide independent control to each LED unit 21 under a daisy chain configuration. Thus, when any one of the LED units 21 fails, the other LED units 21 are not affected. When any one of the LED units 21 fails, the subsequent LED units 21 are still able to operate (e.g., able to perform a light-emitting function).

On the other hand, the present invention achieves the configuration effect in a low-cost manner while minimizing changes to the hardware architecture of the LED string 20 and the controller 10. In one example, control of the LED string 20 by the controller 10 includes setting and driving. Setting may be performed to assign an identification code, which may be an independent identification, to each LED unit 21 so that the controller 10 can, for example, independently identify each LED unit 21 and facilitate subsequent driving for light emission. Driving is performed, according to instructions, so that each LED unit 21 can have an independent lighting characteristic, effect and/or mode, for example, different colors or brightness levels.

In one example, control of the LED string 20 may be implemented in two stages. In the first stage, a signal including a specific number of bits (also referred to as a setting signal) is used so that each of the LED units 21 can obtain a corresponding identification value (or code) based on the number of bits. In the second stage, a signal (also referred to as an indication signal) that is used in association with the identification value (or code) and includes a lighting instruction is used so that the corresponding LED unit 21 can emit light according to the instruction in the indication signal. In one example, the number of bits of the setting signal may be taken from a representation of an RGB color space (gray scale) that the controller 10 uses when driving the LED string 20 to emit light. Accordingly, additional functionality can be achieved under the existing hardware architecture without requiring changes to the physical wiring or circuit layout, and the signaling scheme can be simplified because no additional control signals, protocol overhead, or data formatting requirements are needed, thereby reducing overall system complexity and cost.

It should be understood that these two stages may be independent of each other. In another example, both the setting and the driving described above may be implemented using bits, for example, using a bit signal or a bitstream. A bitstream can be understood as a sequence of bits having characteristics including the number of bytes and a corresponding bit depth, which defines the color depth. For example, in an 8-bit case, the number of bits is 8 and the corresponding bit depth is 256(2^8). Thus, the bitstream can represent the number of bits used for the emitted light color of each LED unit 21.

In one example, the controller 10 may be a micro control unit (MCU). The controller 10 includes an output terminal 11. The LED string 20 includes a plurality of LED units 21, a first line 22, and a second line 23. In one example, the LED units 21 on the LED string 20 are connected in series with each other, and may thereby form a daisy-chain for data propagation, while the controller 10 and the respective LED units 21 are connected in parallel for broadcasting control signals.

The number of the LED units 21 is n, and the LED units 21 are connected in series from 1 to n in order. For purposes of illustration, FIG. 1 only shows a single LED string 20. However, the plurality of LED strings 20 arranged in a parallel configuration may also be available, which may all be controlled by a single controller 10, or each string may be controlled by a corresponding controller 10. The number of the LED units 21 on each string of the LED string 20 may be the same or different according to requirements. On the other hand, FIG. 1 only shows the first to fourth and the (n)th LED units 21. In the following description, some content will generically refer to a certain one of the LED units 21 on the LED string 20 and its components or corresponding features by using an index i. The index i is an integer between 1 and n, for convenience of explanation.

Each of the LED unit 21(i) includes a driver circuit 211(i), an LED chip 212(i), a counter 213(i), a temporary storage element 214(i), and a storage element 215(i), where i is an integer between 1 and n indicating which LED unit 21 on the LED string 20 is being referred to. The driver circuit 211(i) is connected to the LED chip 212(i), the counter 213(i), the temporary storage element 214(i), and the storage element 215(i). In one example, the storage element 215(i) is a non-volatile memory. However, the invention is not limited thereto, and any element capable of storing data even after power-off may be used, such as a fuse, a one-time programmable ROM (OTP ROM), or a flash ROM, among others.

In this example, each LED unit 21(i) is a commonly used three-pin LED, including a data input pin (DI pin), a bidirectional pin, and a data output pin (DO pin). Corresponding to FIG. 1, each LED unit 21(i) has an input terminal 21a(i), a bidirectional terminal 21b(i), and an output terminal 21c(i). The input terminals 21a(i) are connected in parallel to the output terminal 11 of the controller 10 through the first line 22, and the bidirectional terminals 21b(i) and the output terminals 21c(i) are connected in series with each other through the second line 23. The bidirectional terminal 21b(1) of the first LED unit 21(1) is connected to ground, and the output terminal 21c(n) of the (n)th (last) LED unit 21(n) is left unconnected. The output terminal 21c(i) of each LED unit 21(i) is connected, via the second line 23, to the bidirectional terminal 21b(i+1) of the next LED unit 21(i+1). The second line 23 may include a plurality of serial connection lines 231, and the entirety of these connection lines 231 may be regarded as a single connection line that is connected in series among the LED units 21(i). Before configuration, the bidirectional terminal 21b(i) and the output terminal 21c(i) of each LED unit 21(i) are preset to be at a high level.

The counter 213(i) is configured, when the driver circuit 211(i) receives a setting signal, to count a number of bits in the setting signal. In this example, the setting signal is implemented as a bitstream, and the counting merely represents the number of bits contained in the bitstream. This counting only reflects the length of the bitstream and is not related to the number of representable states of Z-bit data (e.g., 2^Z). In other words, if the bitstream contains Z bits, the counting yields Z, whereas the possible 2^Z states associated with Z-bit data are not part of the counting.

Before configuration, the bidirectional terminal 21b(i) and the output terminal 21c(i) of each LED unit 21(i) are preset to be at the high level, except for the first LED unit 21(1), whose bidirectional terminal 21b(1) is coupled to ground. Each LED unit 21(i) is designed such that, after completion of a cumulative bit-counting operation, when the bidirectional terminal 21b(i) detects or is at a low level, the count of the counter 213(i) is written into the temporary storage element 214(i). Since the bidirectional terminal 21b(i) of the LED unit 21(i) is connected to the output terminal 21c(i−1) of the preceding LED unit 21(i−1), a transition of the output terminal 21c(i−1) to the low level causes the bidirectional terminal 21b(i) to correspondingly be at the low level or to detect the low level. Accordingly, the writing of the count into the temporary storage element 214(i) of the LED unit 21(i) can be triggered by the level transition occurring at the output terminal 21c(i−1) of the preceding LED unit 21(i−1), once the cumulative bit-counting operation for that LED unit has been completed.

In other examples, the bidirectional terminal 21b(i) and the output terminal 21c(i) may be preset to be at the low level before configuration, and the LED unit 21(i) may be designed such that, when the bidirectional terminal 21b(i) detects or is at the high level, the count of the counter 213(i) is written into the temporary storage element 214(i), once the cumulative bit-counting operation for that LED unit has been completed.

On the other hand, the temporary storage element 214(i) is configured, when the driver circuit 211(i) receives a programming command, to write the count temporarily stored in the temporary storage element 214(i) into the storage element 215(i).

In this example, the LED string 20 includes n LED units 21, where n is an integer greater than 1. As shown in FIG. 1, the LED units 21(1), 21(2), 21(3), 21(4), and 21(n), which are connected in series from the controller 10, are illustrated.

The output terminal 11 of the controller 10 is connected in parallel, through the first line 22, to the input terminals 21a(1), 21a(2), 21a(3), 21a(4), and 21a(n) of the LED units 21(1), 21(2), 21(3), 21(4), and 21(n), respectively. The LED units 21 are connected in series with each other (i.e., in a daisy-chain manner) through the connection lines 231 of the second line 23.

The steps of a configuration method for the LED units 21(i) will be described below.

The controller 10, through the output terminal 11 and via the first line 22, sends to each LED unit 21(i) a setting signal including mx bits, where x is an integer greater than 1 and less than or equal to (n−1). In the example, index x represents a cycle (iteration) index of the setting signal. For example, the setting signal including m₁ bits represents the first setting signal sent, a setting signal including m₂ bits represents the second setting signal sent, and so on. The setting signal including mₓ bits represents the (x)th setting signal sent. After receiving the setting signal, the counter 213(i) of each LED unit 21(i) performs a counting operation on the number of bits (mₓ) of the setting signal, and the resulting count value is the bit count mₓ. Next, an (x)th LED unit 21(x) is configured such that, after the cumulatively added count has been established by cumulatively counting the numbers of bits m₁ through mₓ₋₁ of the setting signals, when the output terminal 21c(x−1) of the (x−1) th LED unit 21(x−1) is switched from the high level to the low level, to write the cumulatively added count into the temporary storage element 214(x). That is, after each LED unit 21(i) receives the (x−1)th setting signal, the cumulatively counted number corresponds to a sum of bit counts m₁ through m₍ₓ₋₁₎. At this point, for the (x)th LED unit 21(x), the cumulative bit-counting operation is completed (after receiving the (x−1)th setting signal). Since the output terminal 21c(x−1) of the (x−1)th LED unit 21(x−1) is at the low level (the next LED unit detects change of the level at the bidirectional terminal), the accumulated count is written into the temporary storage element 214(x) of the (x)th LED unit 21(x). Meanwhile, the (x)th LED unit 21(x) is configured such that its output terminal 21c(x) switches from the high level to the low level. In the next cycle, because the bidirectional terminal 21b(x+1) of the (x+1)th LED unit 21(x+1) is connected to the output terminal 21c(x) of the (x)th LED unit 21(x), the (x+1)th LED unit 21(x+1) detects the switching from the high level to the low level. Accordingly, for the (x+1)th LED unit 21(x30 1), the count of the counter 213(x+1) is written into the temporary storage element 214(x+1), after receiving the (x)th setting signal). For example, when the controller 10, through the output terminal 11 and the first line 22, sends the first setting signal including m₁ bits to each LED unit 21(i), the output terminal 21c(1) of the first LED unit 21(1) switches from the high level to the low level. The bidirectional terminal 21b(2) of the second LED unit 21(2) is connected to the output terminal 21c(1) of the first LED unit 21(1), and therefore detects the switching from the high level to the low level. For the second LED unit 21(2), the count m₁ of the counter 213(2) is written into the temporary storage element 214(2). Then, the above steps are repeated x times, which in this example is repeated (n−1) times, until the cumulatively added count of the counter 213(n) of the (n)th LED unit 21(n) is written into the temporary storage element 214(n). In this example, the count of the counter 213(i) is cumulative before being reset. For example, when the controller 10 sends the fourth setting signal including m₄ bits to each LED unit 21(i), the counter 213(5) of the fifth LED unit 21(5) continues adding m₄ to an already counted value of (m₁+m₂+m₃), so that the count becomes (m₁+m₂+m₃+m₄). (It should be understood that the counters of the other LED units behave similarly, except that the LED units after the fifth LED unit have not yet written their counts, whereas the first to fourth LED units have already written their counts.)

The output terminal 21c(5) of the fifth LED unit 21(5) switches from the high level to the low level. The bidirectional terminal 21b(6) of the sixth LED unit 21(6) is connected to the output terminal 21c(5) of the fifth LED unit 21(5) and therefore detects the switching from the high level to the low level. For the sixth LED unit 21(6), the count (m₁+m₂+m₃+m₄+m₅) of the counter 213(6) is written into the temporary storage element 214(6). It should be understood that the number of bits of the setting signal is used here as an identifier of each LED unit 21(i), rather than the payload of the setting signal. Therefore, the setting signal may be configured primarily to allow each LED unit 21(i) to be identified, and does not necessarily carry any specific command or instruction. In addition, each mi may be the same value or different values. Because the counter is used cumulatively, regardless of whether the individual mᵢ values are the same or different, the count written into the temporary storage element 214(i) of each LED unit 21(i) is different from that of any other LED unit 21(i), thereby achieving a configuration effect. In other words, through counting in each repetition and writing the count, each LED unit 21(i) is assigned a different numerical value.

After the count is written into the temporary storage element 214(i) of an LED unit 21(i), the counter 213(i) continues the cumulative counting. However, because the bidirectional terminal 21b(i) has already switched to the low level, the subsequently accumulated value will no longer be written into the temporary storage element 214(i). Only for an LED unit 21(i) whose bidirectional terminal 21b(i) has not yet switched to the low level will the cumulative value be written into the temporary storage element 214(i) after the bidirectional terminal 21b(i) switches to the low level.

When the cumulatively added count of the counter 213(n) of the nth LED unit 21(n) is written into the temporary storage element 214(n), the configuration of all the LED units 21(i) is completed in the sense that a count has been written into the temporary storage element 214(i) of each LED unit 21(i). Next, the controller 10, via the first line 22, sends a programming signal to each LED unit 21(i). Upon receiving the programming signal, each LED unit 21(i) writes the count stored in its temporary storage element 214(i) into its storage element 215(i). In this manner, configuration is completed: a count is written into each LED unit 21(i), and these counts are all different numerical values, which serve as identifiers.

It should be understood that the timing and condition under which the accumulated count is written by the (x)th LED unit are not limited to a single implementation. In some examples, the writing operation of the (x)th LED unit occurs after the (x−1)th setting signal has been received, such that cumulative bit counting up to m₁ through mₓ₋₁ has been completed, and when a low-level condition is detected at the bidirectional terminal. In other examples, completion of cumulative bit counting corresponding to m₁ through mₓ₋₁ constitutes a prerequisite condition for writing, and the writing operation is triggered by detection of a level change, such as a transition to a low level, at the bidirectional terminal.

In other words, receipt of the (x−1)th setting signal and completion of the corresponding cumulative bit counting may establish a ready state for writing, while detection of the low-level condition serves as a trigger to initiate the writing operation. The present invention is not limited to the relative ordering or implementation details of these conditions, so long as the writing operation is performed based on cumulative bit counting up to m₁ through mₓ₋₁₎ in association with the detected level condition.

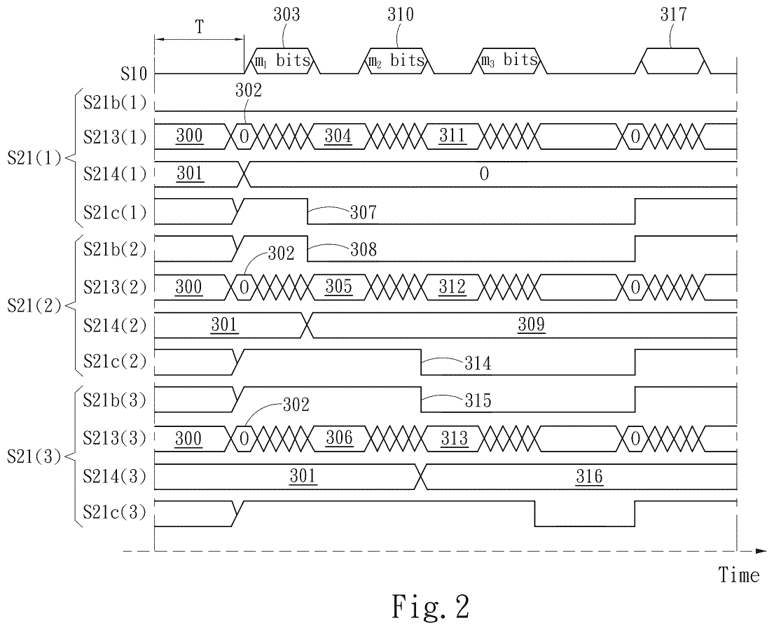

FIG. 2 shows a timing diagram of the above steps in one example. S10 denotes the signal sent by the controller 10 over time. S21(1), S21(2), and S21(3) denote operations of the LED units 21(1), 21(2), and 21(3) over time. S21b(1), S21b(2), and S21b(3) denote operations of the bidirectional terminals 21b(1), 21b(2), and 21b(3) over time. S213(1), S213(2), and S213(3) denote operations of the counters 213(1), 213(2), and 213(3) over time. S214(1), S214(2), and S214(3) denote operations of the temporary storage elements 214(1), 214(2), and 214(3) over time. S21c(1), S21c(2), and S21c(3) denote operations of the output terminals 21c(1), 21c(2), and 21c(3) over time.

In addition, in FIG. 2, a data block 300 denotes a previous count value remaining in the counters 213(1), 213(2), and 213(3), and a data block 301 denotes a count value previously stored in the temporary storage elements 214(1), 214(2), and 214(3), which corresponds to the value of the data block 300. Initially, the controller 10 outputs a low level for a period of time T, which corresponds to the signal S10. The LED units 21 are configured such that, when the low level is detected continuously for the period of time T, a reset is performed. Thus, after the period of time T elapses, a reset 302 is entered, the counts of the counters 213(1), 213(2), and 213(3) may start from zero, and the count values stored in the temporary storage elements 214(1), 214(2), and 214(3) are cleared. The bidirectional terminal 21b(1) of the first LED unit 21(1) has no preceding LED unit to be connected to and is connected to ground, so it remains at the low level. The output terminals 21c(2) and 21c(3) and the bidirectional terminals 21b(2) and 21b(3) of the second and subsequent LED units 21(2) and 21(3) remain at the high level after the reset 302.

The controller 10 then outputs a first setting signal 303 including m₁ bits. After the LED units 21(1), 21(2), and 21(3) receive the first setting signal 303, the counters 213(1), 213(2), and 213(3) count m₁ (data blocks 304, 305, and 306). After the first LED unit 21(1) receives the first setting signal 303, its output terminal 21c(1) drops from the high level to the low level (data block 307). The bidirectional terminal 21b(2) of the second LED unit 21(2) correspondingly transitions to the low level (data block 308), and the count m₁ of the counter 213(2) is written into the temporary storage element 214(2) (data block 309). Next, the controller 10 sends a second setting signal 310 including m₂ bits. After the LED units 21(1), 21(2), and 21(3) receive the second setting signal 310, the counters 213(1), 213(2), and 213(3) continue counting m₂ (data blocks 311, 312, and 313), resulting in an accumulated count of (m₁+m₂). After the second setting signal 310 is received, the output terminal 21c(1) of the first LED unit 21(1) remains at the low level, and the bidirectional terminal 21b(2) of the second LED unit 21(2) also remains at the low level. The output terminal 21c(2) of the second LED unit 21(2) drops from the high level to the low level (data block 314). The bidirectional terminal 21b(3) of the third LED unit 21(3) correspondingly drops to the low level (data block 315), and the accumulated count (m₁+m₂) of the counter 213(3) is written into the temporary storage element 214(3) (block 316).

In this manner, the operation continues until the cumulatively added count of the counter 213(n) of the nth LED unit 21(n) is written into the temporary storage element 214(n). Thereafter, the controller 10 sends a programming signal 317 to each LED unit 21. Upon receiving the programming signal, each LED unit 21 writes the count stored in its temporary storage element 214 into its storage element 215, thereby completing the configuration.

After the configuration is completed, the storage element 215(2) of the second LED unit 21(2) stores the value m₁, the storage element 215(3) of the third LED unit 21(3) stores the value (m₁+m₂), and the storage element 215(n) of the n-th LED unit 21(n) stores the value (m₁+m₂ . . . +mₙ₋₁). Because the counter performs cumulative counting, regardless of whether the individual bit counts are the same or different, the value stored in each storage element 215 is a different value. Thus, the stored values can be used as position identifiers for the respective LED units 21 on the LED string 20.

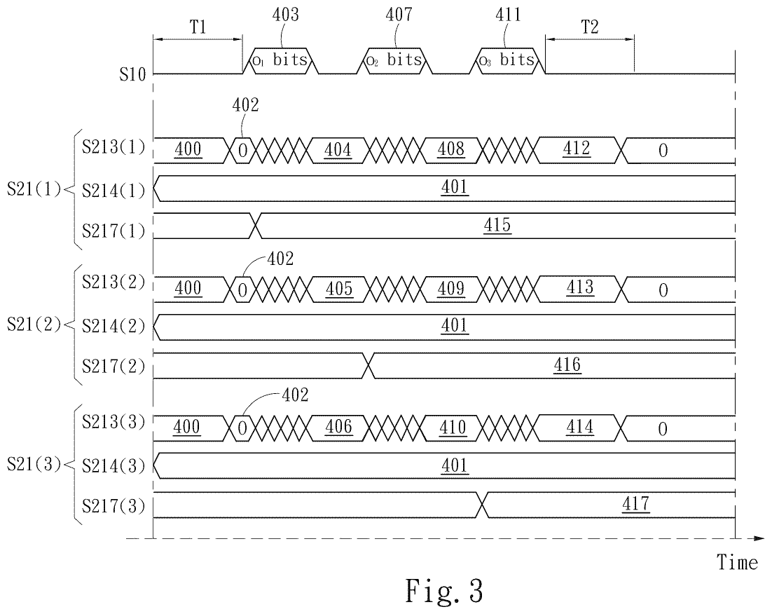

A method of driving the LED string 20 after completion of configuration will now be described. FIG. 3 shows a timing diagram of driving the LED string 20 in an example.

The controller 10 sends to each of the LED units 21 a bit signal including oⱼ bits. Then, the counter 213 of each LED unit 21 counts a number of bits oⱼ of the bit signal. The above-mentioned steps are repeated y times, where y is an integer from 1 to not greater than n, and j is from 1 to y. In the example, j is equal to y and represents a cycle (iteration) index of the bit signal. For the LED units 21, the bit count is cumulatively added, resulting in a second accumulated count. When the second accumulated count reaches the first accumulated count written into the temporary storage element 214 of that LED unit 21, the bit signal is stored by that LED unit 21. The stored bit signal serves as a lighting instruction for the LED unit 21.

In FIG. 3, a data block 400 denotes a previous count value remaining in the counters 213(1), 213(2), and 213(3), and a data block 401 denotes a count value previously stored in the temporary storage elements 214(1), 214(2), and 214(3), which corresponds to the value of the data block 400. The controller 10 first outputs a low level for a period of time T1. The LED units 21 are configured such that, when the low level is detected continuously for the period of time T1, a reset is performed. Thus, after the period of time T1 elapses, a reset (402) is entered.

The controller 10 then outputs a first bit signal 403 including o₁ bits. After the LED units 21(1), 21(2), and 21(3) receive the first bit signal 403, the counters 213(1), 213(2), and 213(3) count o₁ (data blocks 404, 405, and 406). After the first LED unit 21(1) receives the first bit signal 403, it compares the count o₁ with the value stored in the storage element 215(1). If the count o₁ is less than the stored value, the first LED unit 21(1) may disregard the received bit signal, meaning that the first LED unit 21(1) does not respond to or operate according to the first bit signal 403. If the count o₁ is equal to or greater than the stored value (it should be understood that, because counting is used, even if o₁ is greater than the stored value, the “equal to” condition will have been satisfied first), the first LED unit 21(1) stores the received bit signal. The first bit signal 403 then serves as a lighting instruction for the first LED unit 21(1) thereafter.

Similarly, after the second LED unit 21(2) receives the first bit signal 403, it compares the count o₁ with the value stored in its storage element 215(2). If the count o₁ is less than the stored value, the second LED unit 21(2) disregards the received bit signal, meaning that the second LED unit 21(2) does not respond to or operate according to the first bit signal 403. If the count o₁ is equal to or greater than the stored value, the second LED unit 21(2) stores the received bit signal, and the first bit signal 403 then serves as a lighting instruction for the second LED unit 21(2) thereafter.

In the driving method described with reference to FIG. 3, the bit signals, such as the bit signals 403, 407, and 411, function as lighting instructions and are also implemented as bitstreams. Here, both counting and the bit depth corresponding to the bit signal are involved. For example, when the bitstream has Z bits, the count o₁ corresponds to Z, and the number of states corresponding to the Z bits is 2^Z. The former (counting) is related to how the LED unit 21 that receives the bitstream is identified and/or addressed in accordance with the counting, and the latter (the number of states) is related to what color should be emitted by the addressed LED unit 21. For example, the LED unit 21 may emit light according to the 2^Z states represented by the number of bits.

In the example of FIG. 3, after the LED units 21(1), 21(2), and 21(3) receive the bit signals 403, 407, and 411, respectively, the counts are all greater than or equal to the values stored in the storage elements 215(1), 215(2), and 215(3). Therefore, the LED units 21(1), 21(2), and 21(3) all store the bit signals 403, 407, and 411, respectively, for example, in the temporary storage elements 214 or the storage elements 215. In the operations S21(1), S21(2), and S21(3), S217(1), S217(2), and S217(3) represent the bit signals 403, 407, and 411 stored by the LED units 21(1), 21(2), and 21(3), respectively, and are shown as data blocks 415, 416, and 417. The bit signals 403, 407, and 411 may be data packets, and each LED unit 21(1), 21(2), and 21(3) emits light according to the corresponding packet.

In FIG. 3, the data block 407 denotes a second bit signal including o₂ bits. Data blocks 408, 409, and 410 denote that the counters 213(1), 213(2), and 213(3) continue counting o₂ for the second bit signal, resulting in an accumulated count of (o₁+o₂). The data block 411 denotes a third bit signal including o₃ bits. Data blocks 412, 413, and 414 denote that the counters 213(1), 213(2), and 213(3) continue counting o₃ for the third bit signal, resulting in an accumulated count of (o₁+o₂+o₃).

When the nth LED unit 21(n) has stored the received bit signal, distribution of data to be used prior to light emission is completed. Then, the controller 10 sends a lighting signal to each LED unit 21. Upon receiving the lighting signal, each LED unit 21 emits light according to the stored bit signal. In this example, when the controller 10 outputs a low level continuously for a period of time T2, this is regarded as the lighting signal, and the LED units 21 emit light according to the stored bit signals.

What is claimed is:

1. A control circuit for a light-emitting diode (LED) string, comprising:
a controller; and
an LED string including n LED units, where n is a number of the LED units, an input terminal of the respective LED units being connected to the controller through a first line, and a bidirectional terminal and an output terminal of the respective LED units being connected in series with each other and to the controller through a second line;
wherein each of the LED units comprises an LED chip, a driver circuit, a storage element, a temporary storage element and a counter, and the driver circuit is connected to the LED chip, the storage element, the temporary storage element and the counter;
wherein the control circuit is configured to perform the following steps:
step 1-1: the controller, via the first line, sends to each of the LED units a setting signal including mᵢ bits;
step 1-2: the counter of each LED unit counts a number of bits mᵢ of the setting signal;
step 1-3: steps 1-1 to 1-2 are repeated x times, where x is an integer from 1 to not greater than n−1, and i is from 1 to x, wherein a bit count obtained in step 1-2 is cumulatively added, resulting in a first accumulated count, and the (x)th LED unit is configured, after receiving the (x−1)th setting signal, to write the first accumulated count into the temporary storage element; and
step 1-4: the controller, via the first line, sends a programming signal to each of the LED units, and each LED unit, upon receiving the programming signal, writes the first accumulated count stored in the temporary storage element into the storage element;
wherein the first accumulated count written into the storage elements of the respective LED units is different for the respective LED units.

2. The control circuit according to claim 1, wherein after the first accumulated count is written into the temporary storage element of the LED unit, the temporary storage element of that LED unit is no longer written with the first accumulated count.

3. The control circuit according to claim 1, wherein the output terminal of each of the LED units is preset to a first level, and in step 1-3, the (x)th LED unit, after receiving the (x−1)th setting signal, changes its output terminal from the first level to a second level.

4. The control circuit according to claim 3, wherein the output terminal of the (x)th LED unit is changed from the first level to the second level when a cumulative bit counting of m₁ to mₓ₋₁ is completed.

5. The control circuit according to claim 4, wherein following the change of the bidirectional terminal of the (x+1)th LED unit from the first level to the second level with the output terminal of the (x)th LED unit being at the second level, the first accumulated count is written into the temporary storage element of the (x)th LED unit, after receiving the (x)th setting signal.

6. The control circuit according to claim 1, wherein the output terminal of each of the LED units is preset to a first level, and in step 1-3, the (x)th LED unit, when a cumulative bit counting of m₁ to mₓ₋₁ is completed, changes its output terminal from the first level to a second level.

7. The control circuit according to claim 6, wherein the output terminal of the (x)th LED unit is changed from the first level to the second level after receiving the (x−1)th setting signal.

8. The control circuit according to claim 7, wherein following the change of the bidirectional terminal of the (x+1)th LED unit from the first level to the second level with the output terminal of the (x)th LED unit being at the second level, the first accumulated count is written into the temporary storage element of the (x)th LED unit, after receiving the (x)th setting signal.

9. The control circuit according to claim 1, wherein the storage element is a non-volatile memory.

10. The control circuit according to claim 1, wherein the setting signal does not include lighting instruction.

11. The control circuit according to claim 1, wherein x is equal to n−1.

12. The control circuit according to claim 1, wherein after the first accumulated
count is written into the storage element of each of the LED units, the control circuit is configured to perform the following steps:
step 2-1: the controller, via the first line, sends to each of the LED units a bit signal including oⱼ bits;
step 2-2: the counter of each LED unit counts a number of bits oⱼ of the bit signal; and
step 2-3: steps 2-1 to 2-2 are repeated y times, where y is an integer from 1 to not greater than n, and j is from 1 to y, wherein the bit count obtained in
step 2-2 is cumulatively added, resulting in a second accumulated count, and when the second accumulated count reaches the first accumulated count written into the storage element of that LED unit, the bit signal is stored by that LED unit;
wherein the stored bit signal serves as a lighting instruction for the LED unit.

13. The control circuit according to claim 12, wherein the bit signal includes the lighting instruction.

14. The control circuit according to claim 12, wherein the setting signal is associated with identification of the LED unit, and the bit signal is associated with lighting characteristics to be emitted by the particular LED unit.

15. The control circuit according to claim 12, wherein y is equal to j.

16. The control circuit according to claim 1, wherein the LED units on the LED string are arranged in a daisy-chain configuration and the LED units are connected in parallel for signal broadcasting.

17. The control circuit according to claim 1, wherein the bits included in the setting signal in each repetition is same or different.

18. The control circuit according to claim 1, wherein the first accumulated count store in each of the LED units are different.

19. The control circuit according to claim 1, wherein the first accumulated count store in each of the LED units is used to uniquely identify the respective LED unit so as to achieve independent control of the respective LED units.
